(19) United States
(12) Patent Application Publication
(10) Pub. No.: US 2012/0323519 A1
(43) Pub. Date: Dec. 20, 2012

(54) TEST APPARATUS

(75) Inventors: Masahiro ISHIDA, Tokyo (JP); Kiyotaka ICHIYAMA, Tokyo (JP)

(73) Assignee: ADVANTEST CORPORATION, Tokyo (JP)

(21) Appl. No.: 13/524,939

(22) Filed: Jun. 15, 2012

(30) Foreign Application Priority Data
Jun. 17, 2011 (JP) 2011-135708

(51) Int. Cl. G06F 19/00

(52) U.S. Cl. 702/125

(57) ABSTRACT

A pattern generator PG generates control data which specifies a threshold voltage to be compared with a signal under test input to an I/O terminal, and generates expected value data which represents an expected value for the comparison result between the signal under test and the threshold voltage. A threshold voltage generator generates the threshold voltage having a voltage level that corresponds to the control data at every setting timing indicated by a first timing signal. A level comparator compares the voltage level of the signal under test with its corresponding threshold voltage. A timing comparator latches the output of the level comparator at a strobe timing indicated by a second timing signal so as to generate a comparison signal. A timing adjustment unit adjusts the phase of the first timing signal.

### BACKGROUND OF THE INVENTION

1. Field of the Invention

The present invention relates to a test apparatus.

2. Description of the Related Art

In conventional digital wired communication, a binary transmission method using time division multiplexing (TDM) has been the mainstream. In this case, high-capacity transmission has been realized by parallel transmission or high-rate transmission. In order to overcome the physical limitations on parallel transmission, serial transmission, which is high-speed transmission, is performed at a data rate of several Gbps to 10 Gbps or more using a high-speed interface (I/F) circuit. However, the data rate acceleration also has a limit, leading to a problem of BER (Bit Error Rate) degradation due to high-frequency loss or reflection in the transmission line.

On the other hand, with the digital wireless communication method, multi-bit information carried by a carrier signal is transmitted and received. That is to say, the data rate is not directly limited by the carrier frequency. For example, in QAM (Quadrature Amplitude Modification), which is the most basic quadrature modulation/demodulation method, 4-value transmission is provided using a single channel. Furthermore, 64-QAM provides 64-value transmission using a single carrier. That is to say, such a multi-valued modulation method raises the transmission capacity without raising the carrier frequency.

Also, such a modulation/demodulation method can also be applied to wired communication in the same way as with wireless communication. Such a modulation/demodulation method has begun to be applied, as the PAM (Pulse Amplitude Modulation) method, QPSK (Quadrature Phase Shift Keying) method, or DQPSK (Differential QPSK) method. In particular, in the field of optical communication, from the cost perspective, it is important to increase the information carried by a single optical fiber. This has shifted the technology trend from binary TDM to transmission using such digital modulation.

In the near future, such a digital modulation/demodulation method has the potential to be applied to a wired interface between devices such as memory, SoC (System On a Chip), etc. However, at the present time, there is no known multi-channel test apparatus which is capable of testing such devices for mass production.

With the conventional test apparatuses for RF signals, signals output from a DUT (Device Under Test) are A/D (analog/digital) converted, and large amounts of data thus obtained are subjected to signal processing (including software processing) so as to perform expected value judgment (Patent documents 1 and 2). Such a method requires an A/D converter to have a high resolution according to the number of voltage levels of the signal to be tested. In order to test a high-speed interface, there is a need to operate such a high-resolution A/D converter at a high rate, leading to a problem of increased costs of such a test apparatus.

Alternatively, another kind of a conventional test apparatus has a configuration in which multiple voltage comparators having different respective threshold values are arranged in parallel, and that is configured to compare the output of each voltage comparator with an expected value (Patent documents 3 and 4). Such a method leads to an increased number of voltage comparators according to the number of comparison levels, resulting in a problem of increased hardware overhead. Also, such an arrangement leads to a problem of degraded voltage comparison precision due to the effects of noise and so forth that occur in the multiple voltage comparators.

Patent document 5 discloses a technique for testing a liquid crystal driving IC (source driver and data driver). Such a liquid crystal driving IC is configured to receive binary serial input data for each pixel that represents the luminance of the pixel, and to output a multi-valued driving voltage to each of multiple data lines. In order to test such a liquid crystal driving IC, a test apparatus includes a low-speed comparison unit configured to compare a driving voltage, which is a signal to be tested, with a comparison voltage that corresponds to the serial input data. Such a method can be applied to a low-speed liquid crystal driving IC. However, this method cannot be applied to the high-speed multi-valued interface signals that have begun to be used in recent years.

In order to test such a liquid crystal driving IC, a test apparatus employing a differential detector, a window comparator, and a device configured to generate a multi-valued reference voltage, has also been proposed (Patent document 6). However, such a test apparatus requires a high-speed D/A converter and a high-speed operational amplifier. Thus, it is difficult to apply such a test apparatus to a test for high-speed multi-valued interface signals.

### RELATED ART DOCUMENTS

### Patent Documents

### [Patent Document 1]

Japanese Patent Application Laid Open No. 2003-98230

### [Patent Document 2]

Japanese Patent Application Laid-Open No. H05-87578

### [Patent Document 3]

Japanese Patent Application Laid-Open No. S58-79171

### [Patent Document 4]

U.S. Pat. No. 7,162,672 Specification

### [Patent Document 5]

Japanese Patent Application Laid-Open No. H08-313592

### [Patent Document 6]

Japanese Patent Application Laid-Open No. H06-235754

In a case in which all the I/O ports of a device such as memory, an MPU (Micro Processing Unit), etc., are each configured as a high-speed multi-valued interface instead of a conventional interface, such a single device has from tens of to a hundred or more I/O ports. Accordingly, there is a need to test such hundreds of I/O ports at the same time. That is to say, there is a need to provide a test apparatus having thousands of input/output channels for digitally modulated/demodulated signals. Furthermore, real-time testing at the hardware level is required in all steps due to the CPU resource limits of the test apparatus.

Also, it is very effective for a manufacturer to use a test apparatus configured to test, in a real time manner, test signals modulated in various kinds of formats, such as amplitude modulation (AM), frequency modulation (FM), amplitude shift keying (ASK), phase shift keying (PSK), and so forth.

### SUMMARY OF THE INVENTION

The present invention has been made in view of such a situation. Accordingly, it is an exemplary purpose of an embodiment of the present invention to provide a test apparatus which is capable of testing a high-speed multi-valued signal.

An embodiment of the present invention relates to a test apparatus configured to test a signal under test which is output from a device under test. The signal under test has a voltage level that changes according to its value (symbol). The test apparatus comprises an input pin configured to receive the signal under test as an input signal, a pattern generator, a threshold voltage generator, a level comparator, a timing comparator, and a timing adjustment unit.

The pattern generator is configured to generate control data that specifies a threshold voltage to be compared with the signal under test input to the input pin, and to generate expected value data which represents an expected value for the comparison result between the signal under test and the threshold voltage. The threshold voltage generator is configured to receive the control data, and to generate a threshold voltage having a voltage level that corresponds to the control data at every setting timing indicated by a first timing signal. The level comparator is configured to compare the voltage level of the signal under test with the corresponding threshold voltage. The timing comparator is configured to latch the output of the level comparator at a strobe timing indicated by a second timing signal so as to generate a comparison signal. The digital comparator is configured to compare the comparison signal with the expected value data, and to generate a judgment signal which indicates whether they are matching or mismatching. The timing adjustment unit is configured to adjust the phase of the first timing signal relative to the signal under test and the second timing signal.

Such an embodiment provides a test apparatus having small hardware overhead as compared with the conventional test apparatuses described in Patent documents 3 and 4. In the test operation, typical test apparatuses have information with respect to an expected value of the signal under test to be output from the device under test, i.e., the amplitude level of the signal under test. Thus, by dynamically changing the threshold voltage to be supplied to the comparator unit according to the expected value, such an arrangement requires only a small number of comparator units to test a signal under test having a high data rate, e.g., a data rate of several Gbps or more.

With such an arrangement, the threshold voltage generated by the threshold voltage generator becomes stable after a certain amount of settling time elapses from the setting timing. With such an embodiment, by optimizing the phase of the first timing signal relative to the signal under test and the second timing signal, such an arrangement is capable of latching the comparison result between the signal under test and the threshold voltage at a strobe timing that corresponds to the second timing signal after settling of the threshold voltage is completed.

Also, in the operation for calibration of the first timing signal, a predetermined calibration signal may be input to the input pin over multiple cycles. Also, the timing adjustment unit may be configured to adjust the phase of the first timing signal relative to the signal under test and the second timing signal, based upon the judgment signal obtained for the multiple cycles.

Also, the timing adjustment unit may be configured to perform the following operation while the phase of the first timing signal is being swept. The aforementioned operation comprises: (1) acquiring the judgment signal for each cycle over the multiple cycles, (2) counting the number of times an event occurs in which the judgment signal indicates matching or otherwise mismatching, and (3) determining, based upon the number of times thus counted, the phase of the first timing signal to be used in a normal test operation.

Also, in the operation for calibration of the first timing signal, a predetermined calibration signal may be input to the input pin over multiple cycles. Also, the timing adjustment unit may be configured to adjust the phase of the first timing signal relative to the signal under test and the second timing signal, based upon the comparison signal obtained for the multiple cycles.

Also, the timing adjustment unit may acquire the comparison signal for each phase over multiple cycles of the first timing signal while the phase is being swept. Also, the timing adjustment unit may determine, based upon the comparison signal thus acquired, the phase of the first timing signal to be employed in a normal test operation.

Also, the calibration signal may be configured as a predetermined fixed voltage. Also, the pattern generator may be configured to generate the control data determined such that the threshold voltage is changed such that it crosses the fixed voltage in the calibration operation.

By employing such a fixed voltage as the calibration signal, such an arrangement eliminates the effects of the settling time required for the calibration signal, thereby optimizing the phase of the first timing signal.

Also, the test apparatus according to an embodiment may further comprise a delay circuit configured to apply an adjustable delay to the second timing signal so as to generate the first timing signal. Also, the timing adjustment unit may be configured to adjust the delay amount to be applied by the delay circuit.

Also, the test apparatus according to an embodiment may further comprise a delay circuit configured to apply an adjustable delay to the first timing signal so as to generate the second timing signal. Also, the timing adjustment unit may be configured to adjust the delay amount to be applied by the delay circuit.

Also, the test apparatus according to an embodiment may further comprise: a timing generator configured to generate a base timing signal; a first delay circuit configured to apply an adjustable delay to the base timing signal so as to generate the first timing signal; and a second delay circuit configured to apply a delay to the base timing signal so as to generate the second timing signal. Also, the timing adjustment unit may be configured to adjust the delay amount to be applied by the first delay circuit.

Also, the timing generator may employ, as the base timing signal, a strobe signal that is asserted at a cycle in which the test apparatus is to perform a comparison operation.

Also, multiple sets, each of which comprises the threshold voltage generator, the level comparator, and the timing comparator, may be arranged for each input pin.

Also, the multiple threshold voltage generators assigned to the same input pin may be configured to generate different respective threshold voltages. Also, the multiple level comparators assigned to the same input pin may be configured to receive the respective threshold voltages from the corresponding threshold voltage generators, and to operate as a window comparator.

Also, the multiple sets, each of which comprises the level comparator and the timing comparator, assigned to the same input pin may be configured to operate as an interleaving comparator that operates in a time sharing manner.

It is to be noted that any arbitrary combination or rearrangement of the above-described structural components and so forth is effective as and encompassed by the present embodiments. Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram which shows a configuration of a test apparatus according to a first embodiment;

FIGS. 2A and 2B are circuit diagrams each showing an example configuration of a threshold voltage generator shown in FIG. 1;

FIG. 3 is a time chart which shows the operation of a voltage margin test performed by the test apparatus shown in FIG. 1;

FIG. 4 is a block diagram which shows a configuration of a test apparatus according to a second embodiment;

FIGS. 5A and 5B are time chart which shows the operation of the test apparatus shown in FIG. 4;

FIG. 6 is a block diagram which shows a configuration of a test apparatus according to a third embodiment;

FIG. 7 is a time chart which shows the operation of the test apparatus shown in FIG. 6;

FIG. 8 is a block diagram which shows a configuration of a test apparatus according to a fourth embodiment;

FIGS. 9A through 9C are block diagrams showing the configurations of test apparatuses according to a first modification through a third modification;

FIG. 10 is a block diagram which shows an example modification of the test apparatus shown in FIG. 4;

FIG. 11 is a time chart which shows the operation of the test apparatus shown in FIG. 10;

FIGS. 12A through 12C are circuit diagrams each showing the configuration of a threshold voltage generator according to a modification;

FIGS. 13A and 13B are diagrams each showing the relation between the threshold voltage and the signal under test;

FIGS. 14A through 14C each show a circuit diagram showing a circuit configuration configured to generate a timing signal and the corresponding waveform diagram;

FIGS. 15A through 15C are diagrams showing the waveforms of the threshold voltage provided by the configuration shown in FIG. 14A with the test rate having been changed.

FIG. 16 is a block diagram which shows a configuration of a test apparatus which is capable of optimizing the setting timing for the threshold voltage;

FIG. 17 is a waveform diagram which shows an example of the operation for calibration of the setting timing for the threshold voltage performed by the test apparatus.

FIG. 18 is a waveform diagram showing the relation between the threshold voltage and the first timing signal; and

FIG. 19 is a graph showing the relation between the delay amount applied by the variable delay circuit and the number of times (probability) an event occurs in which the judgment signal indicates matching.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

A test apparatus according to an embodiment is configured to receive a multi-valued signal to be tested output from a device under test (DUT), and to judge the quality of the DUT. Such a DUT is configured to output a signal to be tested subjected to PAM (pulse amplitude modulation), APSK (amplitude phase shift keying), QAM (quadrature amplitude modulation), QPSK (quadrature phase shift keying), BPSK (binary phase shift keying), or FSK (frequency shift keying), for example. Examples of such possible DUTs include devices such as memory, MPUs, and so forth, having multi-channel I/O ports. However, such a DUT is not restricted in particular.

### First Embodiment

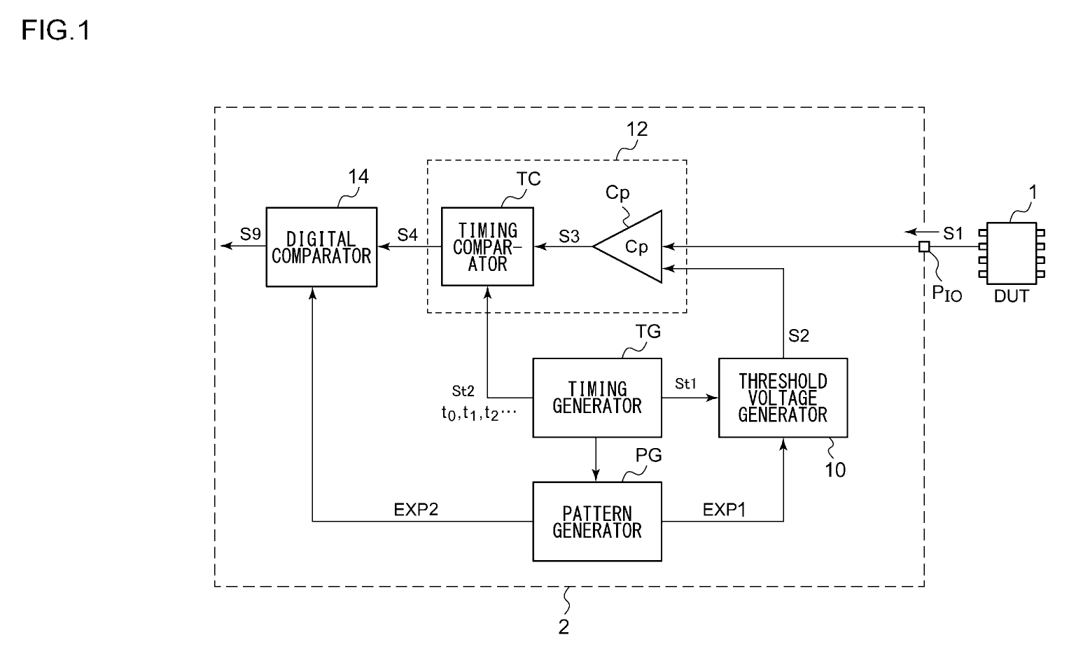

FIG. 1 is a block diagram which shows a configuration of a test apparatus 2 according to a first embodiment. The test apparatus 2 shown in FIG. 1 includes multiple I/O terminals P_{IO} respectively provided to I/O ports of the DUT 1. The test apparatus 2 is arranged such that its I/O ports P_{IO} are each connected to a corresponding I/O port of the DUT 1 via a transmission path, and such that a multi-valued signal S1 is input to each I/O port from the DUT 1. The number of I/O ports P_{IO} can be determined as desired. In a case in which the DUT 1 is configured as memory or an MPU, the number of I/O ports is from several tens to a hundred or more. However, for ease of understanding and simplicity of description, the drawing shows only a single I/O port P_{IO} and a block that corresponds to the single I/O port P_{IO}.

The test apparatus 2 includes a pattern generator PG, a timing generator TG, a comparator unit 12, a threshold voltage generator 10, and a digital comparator 14. The comparator unit 12, the threshold voltage generator 10, and the digital comparator 14 are arranged for each I/O terminal P_{IO}.

The pattern generator PG is configured to generate an expected value data string (which will be referred to as an “expected value string” or “expected value pattern”) EXP which represents an expected value of the signal under test S1 to be sequentially input to the I/O terminal P_{IO}. The expected value data EXP is configured as data that corresponds to each symbol value of the signal under test S1. The expected value data EXP may be configured as data which represents an amplitude (voltage level) that the signal under test S1 is expected to have. The timing generator TG is a unit configured to control the timing of the test sequence, and is configured to generate a timing signal in synchronization with the test rate.

According to the expected value data EXP, the pattern generator PG is configured to generate control data EXP1 which specifies the threshold voltage Vth to be compared with the signal under test S1, and to output the control data EXP1 to the threshold voltage generator 10. Furthermore, the pattern generator PG is configured to generate expected value data EXP2 that represents an expected value for the comparison result between the signal under test S1 and the threshold voltage Vth, and to output the expected value data EXP2 to the digital comparator 14.

The threshold voltage generator 10 is configured to receive the control data EXP1, and to generate a sequence of the threshold voltage Vth (threshold voltage sequence) S2 having a voltage level that corresponds to the control data EXP1 in synchronization with the signal under test S1. Specifically, the threshold voltage generator 10 is configured to generate each threshold voltage Vth at a setting timing t_{V} specified by the first timing signal St1. In the normal test state, the threshold voltage Vth is set to a level that corresponds to the expected voltage level to which the corresponding signal under test S1 is to be set.

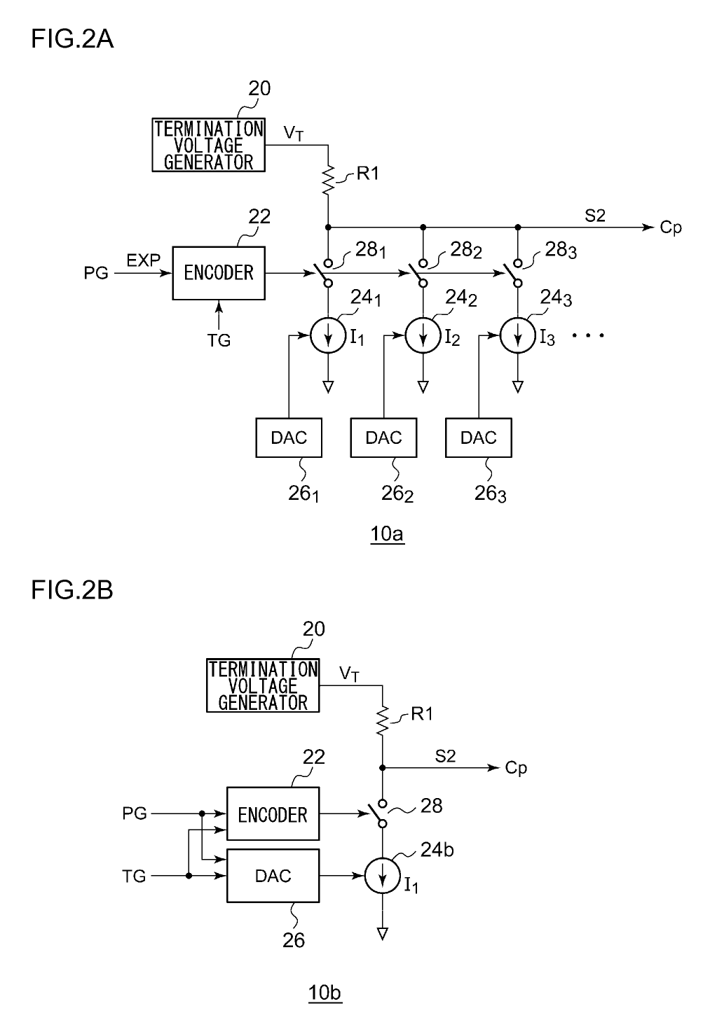

The threshold voltage generator 10 is configured as a current mode logic (CML) type voltage driver in order to follow a signal under test S1 that changes at a rate of several Gbps. FIGS. 2A and 2B are circuit diagrams each showing an example configuration of the threshold voltage generator 10 shown in FIG. 1.

A threshold voltage generator 10a shown in FIG. 2A includes a terminal voltage generator 20, a resistor R1, an encoder 22, multiple current sources 24₁ through 24₃, and multiple D/A converter 26₁ through 26₃. The number of current sources 24 may be determined as desired, and may be designed according to the resolution of the threshold voltage Vth. The terminal voltage generator 20 is configured to generate a terminal voltage V_{T}. The terminal voltage V_{T} thus generated by the terminal voltage generator 20 is applied to one terminal of the resistor R1. The multiple current sources 24₁ through 24₃ are connected to the other terminal of the resistor R1. The current sources 24₁ through 24₃ are respectively configured to generate constant currents I₁ through I₃ according to settings respectively provided by the D/A converters 26₁ through 26₃.

The encoder 22 is configured to operate in synchronization with a timing control signal received from the timing generator TG. At the voltage setting timing (which will also be referred to simply as the “setting timing” hereafter) t_{V} indicated by the timing control signal, according to the expected value data EXP (control data EXP1) received from the pattern generator PG, the encoder 22 is configured to control the on/off states of the respective currents I₁ through I₃ generated by the respective current sources 24₁ through 24₃. The on/off states of the currents I₁ through I₃ may be respectively controlled by the switches 28₁ through 28₃ respectively arranged on the paths of the respective currents I₁ through I₃. In a case in which the current sources 24₁ through 24₃ are each capable of providing the current-zero state, such switches 28₁ through 28₃ may be omitted.

The current sources 24₁ through 24₃ may generate the respective currents I₁ through I₃ having the same current value. In this case, the encoder 22 is configured to convert the expected value data EXP into a thermometer code. In a case in which the currents I₁ through I₃ are weighted in a binary manner, the encoder 22 is configured to convert the expected value data EXP into a binary code.

The threshold voltage generator 10a shown in FIG. 2A is configured to output the voltage that develops at the other terminal of the resistor R1 as a threshold voltage S2 that corresponds to the expected value data EXP.

A threshold voltage generator 10b shown in FIG. 2B includes a variable current source 24b, instead of the multiple current sources 24₁ through 24₃ shown in FIG. 2A. The D/A converter 26 is configured to control the variable current source 24b according to the expected value data EXP. The encoder 22 is configured to control the switch 28 according to the expected value data EXP. In a case in which the variable current source 24b is capable of providing the current-zero state, the switch 28 may be omitted.

Description will be made returning to FIG. 1. The comparator unit 12 is configured to compare the voltage level V_{DUT} of the signal under test S1 with the corresponding threshold voltage Vth. The comparator unit 12 includes a level comparator Cp and a timing comparator TC. The level comparator Cp is configured to compare the voltage level V_{DUT} of the signal under test S1 with the corresponding threshold voltage Vth, and to output a comparison signal S3 which represents the magnitude relation between them. The timing comparator TC is configured to latch the comparison signal S3 received from the level comparator Cp at a strobe timing t_{S} indicated by the second timing signal St2, and to generate a comparison signal S4.

The digital comparator 14 is configured to judge the quality of the DUT 1 based upon the comparison signal S4 received from the comparator unit 12. Specifically, the digital comparator 14 is configured to compare the comparison signal S4 with the expected value data EXP2, and to generate a judgment signal S9 whether or not the comparison signal S4 matches the expected value data EXP2 (PASS or FAIL).

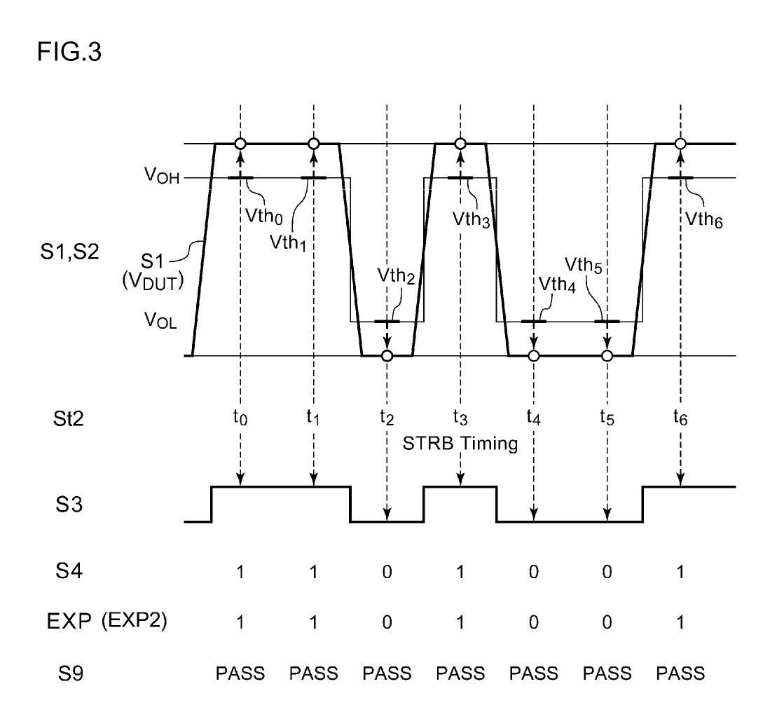

The above is the configuration of the test apparatus 2. Next, description will be made regarding the operation thereof. FIG. 3 is a time chart which shows the operation of a voltage margin test provided by the test apparatus 2 shown in FIG. 1. The signal under test S1 to be received from the DUT 1 is configured as a digital binary signal having a high level (1) and a low level (0). In the voltage margin test, such an arrangement is configured to test whether or not the voltage level V_{DUT} of the signal under test S1 is higher than the upper threshold voltage V_{OH} when it is to be high level (1), and whether or not it is lower than the lower threshold voltage V_{OL} when it is to be low level (0).

The time points t₀, t₁, and so forth, are configured as timings (strobe timings) at which the signal under test S1 is to be judged, and are determined according to the second timing signal St2. The time chart shown in FIG. 3 shows a case in which the expected value data EXP is set to [1, 1, 0, 1, 0, 0, 1] at strobe timings t₀ through t₆. The strobe timing is controlled by the aforementioned timing generator TG.

The threshold voltage generator 10 is configured to receive a string of the expected value data EXP, i.e., [1, 1, 0, 1, 0, 0, 1], as the expected data EXP1, and to generate a sequence S2 of the threshold voltage Vth, i.e., {Vth₀, Vth₁, Vth₂, Vth₃, Vth₄, Vth₅, Vth₆}, that corresponds to the control data EXP1. The threshold voltage Vthᵢ at the i-th strobe timing is set to a voltage level that corresponds to the i-th expected value data EXP[i] included in the expected value data EXP string. Specifically, the threshold voltage generator 10 is configured to generate a threshold voltage V_{OH} having a high level when EXP[i]=1, and to generate a threshold voltage V_{OL} having a low level when EXP[i]=0.

The comparison signal S3 output from the level comparator Cp is latched at strobe timings t₀, t₁, and so forth, thereby generating the comparison signal S4. The digital comparator 14 is configured to compare the comparison signal S4 with the expected value EXP so as to judge the quality (Pass/Fail) of the DUT 1.

The above is the operation of the test apparatus 2 shown in FIG. 1. With the test apparatus 2, by switching the multiple threshold voltages V_{OH} and V_{OL} at a high speed according to the expected value in synchronization with the control signal received from the timing generator TG, such an arrangement is capable of providing a real-time voltage margin test for the DUT 1 configured to output a binary digital signal.

### Second Embodiment

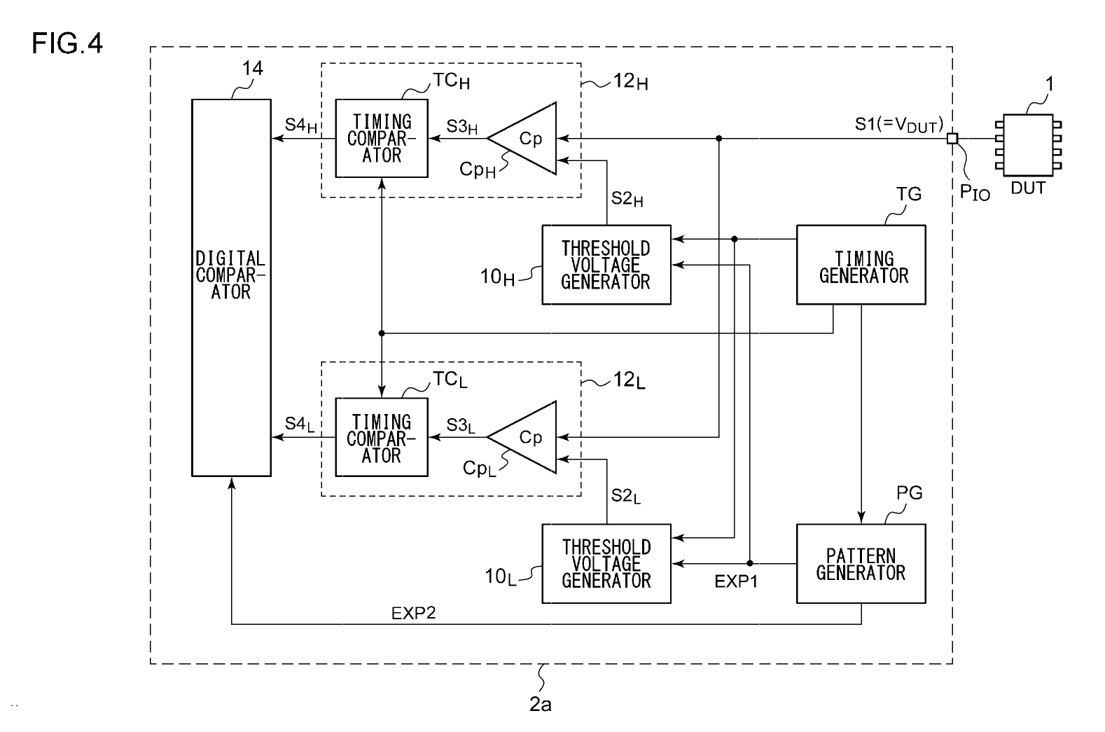

FIG. 4 is a block diagram which shows a test apparatus 2a according to a second embodiment. In the following description of the embodiment, the same configuration as that of the first embodiment will be omitted as appropriate, and description will be made mainly with reference to the points of difference from the first embodiment.

The test apparatus 2a shown in FIG. 4 includes multiple threshold voltage generators 10 and multiple comparators 12 for each I/O pin P_{IO}. FIG. 4 shows an arrangement in which two threshold voltage generators 10_{H} and 10_{L} and two comparator units 12_{H} and 12_{L} are arranged for each I/O pin P_{IO}.

The multiple threshold voltage generators 10_{H} and 10_{L} are configured to generate different respective threshold voltage sequences S2_{H} and S2_{L}. Specifically, the threshold voltage sequences S2_{H} and S2_{L} are generated such that the expected voltage level V_{EXP} is set between them at each strobe timing. For the expected voltage level V_{EXPi} to be set at the i-th strobe timing tᵢ, the voltage level VthHᵢ of the threshold voltage sequence S2_{H} at the i-th strobe timing is represented by VthHᵢ=V_{EXPi}+ΔV_{H}. Furthermore, the voltage level VthLᵢ of the threshold voltage sequence S2_{L} at the i-th strobe timing is represented by VthLᵢ=V_{EXPi}−ΔV_{L}. Here, ΔV_{H} and ΔV_{L} each represent a voltage margin. The threshold voltage generators 10_{H} and 10_{L} are configured to generate threshold pairs the number of which is equal or greater than the number of switchable levels of the expected value voltage V_{EXP}.

The comparators 12_{H} and 12_{L} are respectively configured to compare the signal under test S1 with the threshold voltage sequences S2_{H} and S2_{L}. That is to say, the comparator units 12_{H} and 12_{L} operate as a window comparator.

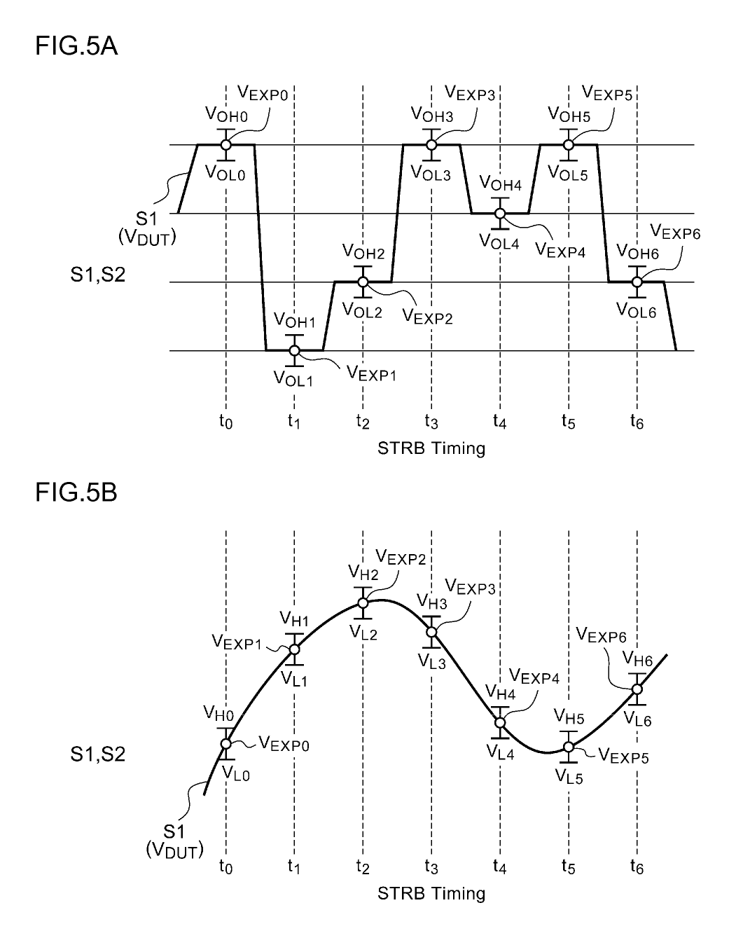

FIGS. 5A and 5B are time charts showing the operation of the test apparatus 2a shown in FIG. 4. FIG. 5A shows an arrangement in which the signal under test S1 to be received from the DUT 1 is switchable between four voltage levels.

The threshold voltage generator 10_{H} is configured to receive the expected value pattern EXP, and to generate the threshold voltage sequence S2_{H}=V_{OH0}, V_{OH1}, and so forth, which are higher than the respective expected voltage levels V_{EXP0}, V_{EXP1}, and so forth, of the signal under test S1. The threshold voltage generator 10_{L} is configured to receive the expected value pattern EXP, and to generate the threshold voltage sequence S2_{L}={V_{OL0}, V_{OL1}, . . . } that are lower than the respective expected voltage levels V_{EXP0}, V_{EXP1}, and so forth, of the signal under test S1.

The comparison signal S3_{H} output from the level comparator Cp of the comparator unit 12_{H} is latched at strobe timings t₀, t₁, and so forth, so as to generate the comparison signal S4_{H}. Similarly, the comparison signal S3_{L} output from the level comparator Cp of the comparator unit 12_{L} is latched at strobe timings t₀, t₁, and so forth, so as to generate the comparison signal S4_{L}. The digital comparator 14 is configured to compare the comparison signals S4_{H} and S4_{L} with the expected value pattern EXP, thereby providing a test for the DUT 1 having a multi-valued interface.

FIG. 5B shows an arrangement in which the signal under test S1 is configured as an analog signal. By generating the threshold voltages V_{OH} and V_{OL} at each strobe timing according to the expected waveform of the signal under test S1, such an arrangement enables pass/fail judgment to be made for the analog signal. In a case in which an analog signal is to be tested, there is a need to design the threshold voltage generators 10_{H} and 10_{L} to each have a resolution that is sufficient for the test accuracy (voltage resolution).

It should be noted that the threshold voltage generators 10_{H} and 10_{L} may be configured to generate the respective threshold voltages V_{OH} and V_{OL} independently. Alternatively, an arrangement may be made in which, when one threshold voltage is set, the other threshold voltage is automatically set by applying an offset or the like to the aforementioned one threshold voltage.

### Third Embodiment

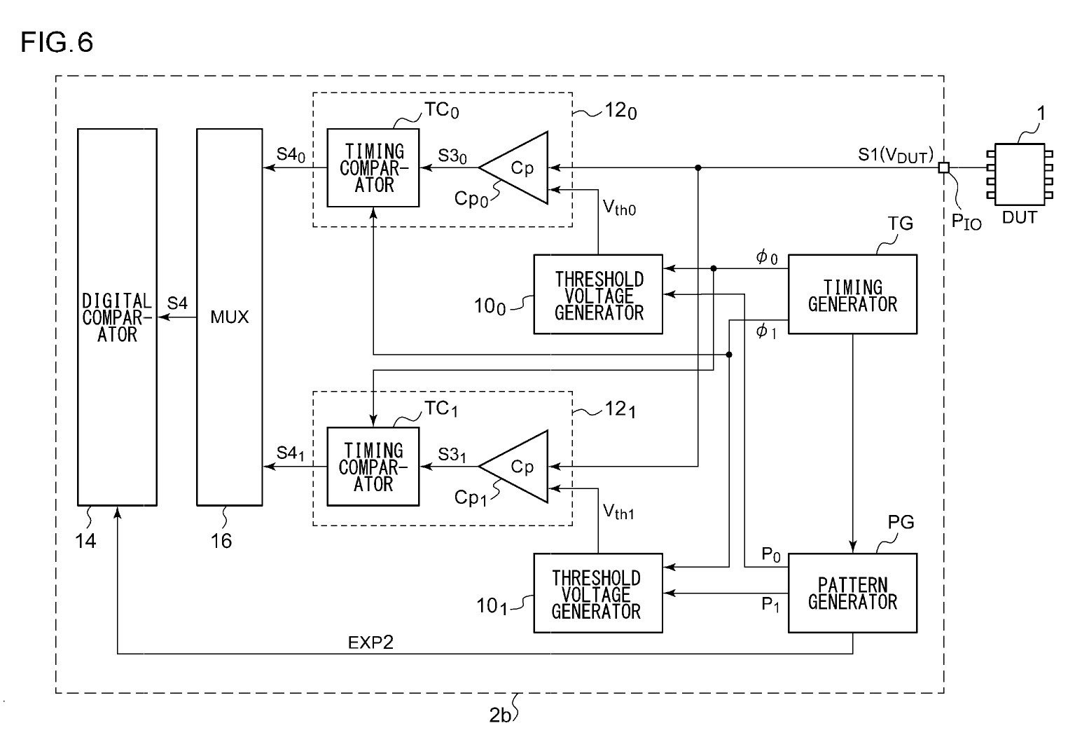

FIG. 6 is a block diagram which shows a configuration of a test apparatus 2b according to a third embodiment. The test apparatus 2b shown in FIG. 6 has a configuration in which multiple threshold voltage generators 10 and multiple comparator units 12 are arranged for each I/O pin P_{IO}, in the same way as the test apparatus 2a shown in FIG. 4.

The multiple comparator units 12₀ and 12₁ assigned to the same input pin P_{IO} are each configured as an interleaving comparator which operates in a time sharing manner. Specifically, at the odd-numbered strobe timings t₁, t₃, and so forth, the comparator unit 12₀ is configured to compare the voltage level V_{DUT} of the signal under test S1 with the threshold voltage Vth₀ received from the threshold voltage generator 10₀. At the even-numbered strobe timings t₀, t₂, and so forth, the comparator unit 12₁ is configured to compare the voltage level V_{DUT} of the signal under test S1 with the threshold voltage Vth₁ received from the threshold voltage generator 10₁. It should be noted that the different respective comparison operations at the odd-numbered timings and the even-numbered timings are described for convenience. Also, these comparison operations may be replaced by one another.

The timing generator TG is configured to generate a control signal φ₀ which indicates the even-numbered strobe timings t₀, t₂, and so forth, and to output the control signal φ₀ thus generated to the timing comparator TC₁ of the comparator unit 12₁ and the threshold voltage generator 10₀. Furthermore, the timing generator TG is configured to generate a control signal φ₁ which indicates the odd-numbered strobe timings t₁, t₃, and so forth, and to output the control signal φ₁ thus generated to the timing comparator TC₀ of the comparator unit 12₀ and the threshold voltage generator 10₁.

In the interleaving operation, the periods of the two threshold voltages Vth₀ and Vth₁ are each double the period of the signal under test S1. Thus, the control signals φ₀ and φ₁ are each configured to have a period that is double the period of the signal under test S1. There is a half-cycle phase shift (the phase is shifted by one cycle of the signal under test S1) between the control signal φ₀ to be supplied to the threshold voltage generator 10₀ and the control signal φ₁ to be supplied to the comparator unit 12₀. This means that the threshold voltage Vth₀ is set before the comparison operation. The same can be said of the threshold voltage generator 10₁ and the comparator unit 12₁.

Furthermore, the pattern generator PG is configured to output, to the threshold voltage generator 10₀, the control data P₀ that corresponds to the expected value included in the expected value pattern EXP at the odd-numbered strobe timings t₁, t₃, and so forth. Moreover, the pattern generator PG is configured to output, to the threshold voltage generator 10₁, the control data P₁ that corresponds to the expected value included in the expected value pattern EXP at the even-numbered strobe timings t₀, t₂, and so forth.

A multiplexer 16 is configured to multiplex the comparison signals S4₀ and S4₁ alternately output from the comparator unit 12₀ and the comparator unit 12₁, and to output the signal thus multiplexed to the digital comparator 14. The comparison signal S4 output from the multiplexer 16 is equivalent to the comparison signal S4 output from the comparator unit 12 shown in FIG. 1.

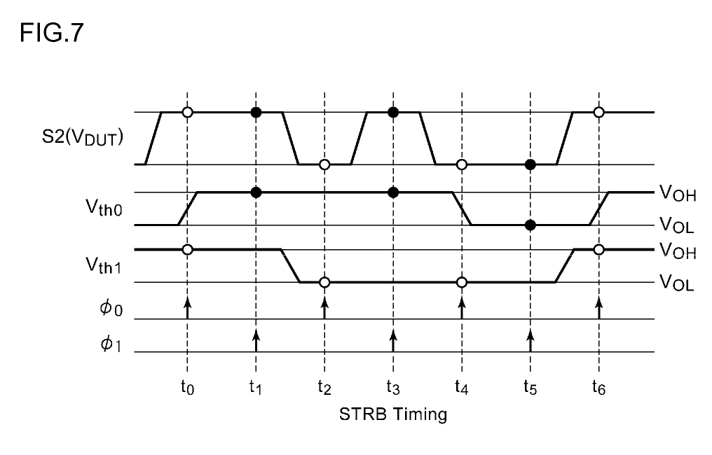

The above is the configuration of the test apparatus 2b shown in FIG. 6. Next, description will be made regarding the operation thereof. FIG. 7 is a time chart which shows the operation of the test apparatus 2b shown in FIG. 6. FIG. 7 shows an arrangement configured to test a binary digital signal, as with that shown in FIG. 2. In the drawing, the open circles each represent a strobe timing generated by the threshold voltage generator 10₁, and the solid circles each represent a strobe timing generated by the threshold voltage generator 10₀.

Description will be made below directing attention to the operations of the threshold voltage generator 10₀ and the comparator unit 12₀. When the control signal φ₀ is asserted at the strobe timing t₀, the threshold voltage generator 10₀ generates the threshold voltage Vth₀ that corresponds to the expected value P₀ that is to be set at the next strobe timing t₁. When the control signal φ₁ is asserted at the next strobe timing t₁, the timing comparator TC₀ of the comparator unit 12₀ latches the comparison signal S3₀ received from the level comparator Cp₀.

Furthermore, the threshold voltage generator 10₁ and the comparator unit 12₁ are configured to perform an operation that is the same as but the inverse of that of the threshold voltage generator 10₀ and the comparator unit 12₀. Specifically, when the control signal φ₁ is asserted at the strobe timing t₁, the threshold voltage generator 10₁ generates the threshold voltage vth₁ that corresponds to the expected value P₁ to be set at the next strobe timing t₂. When the control signal φ₀ is asserted at the next strobe timing t₂, the timing comparator TC₁ of the comparator unit 12₁ latches the comparison signal S3₁ received from the level comparator Cpₗ.

The above is the operation of the test apparatus 2b. The test apparatus 2b shown in FIG. 6 is configured to alternately operate the multiple comparator units 12, thereby providing a test for a signal provided at a higher rate. Furthermore, directing attention to each comparator unit 12, there is a phase shift of one cycle of the strobe signal between the setting timing for the threshold voltage and the strobe timing. Thus, such an arrangement allows the comparison processing to be performed after the threshold voltage generated by the threshold voltage generator 10 becomes stable, thereby providing improved test accuracy. It should be noted that, in a case in which such an arrangement requires a very short period of time to stabilize the threshold voltage, the setting of the threshold voltage Vth may be performed at substantially the same timing as the strobe timing.

Description has been made with reference to FIG. 6 regarding an arrangement in which the two comparator units 12₀ and 12₁ and the two threshold voltage generators 10₀ and 10₁ are operated with two respective phases in an interleaving manner. However, the present invention is not restricted to such an arrangement. Also, an arrangement may be made in which three or more comparator units 12 and three or more threshold voltage generators 10 are operated with three or more respective phases in an interleaving manner.

Such an interleaving technique shown in FIG. 6 can be applied to the test apparatus 2a shown in FIG. 4. In this case, the number of comparator units 12_{H} and 12_{L} and corresponding threshold voltage generators 10_{H} and 10_{L} may be preferably determined according to the number of interleaves.

### Fourth Embodiment

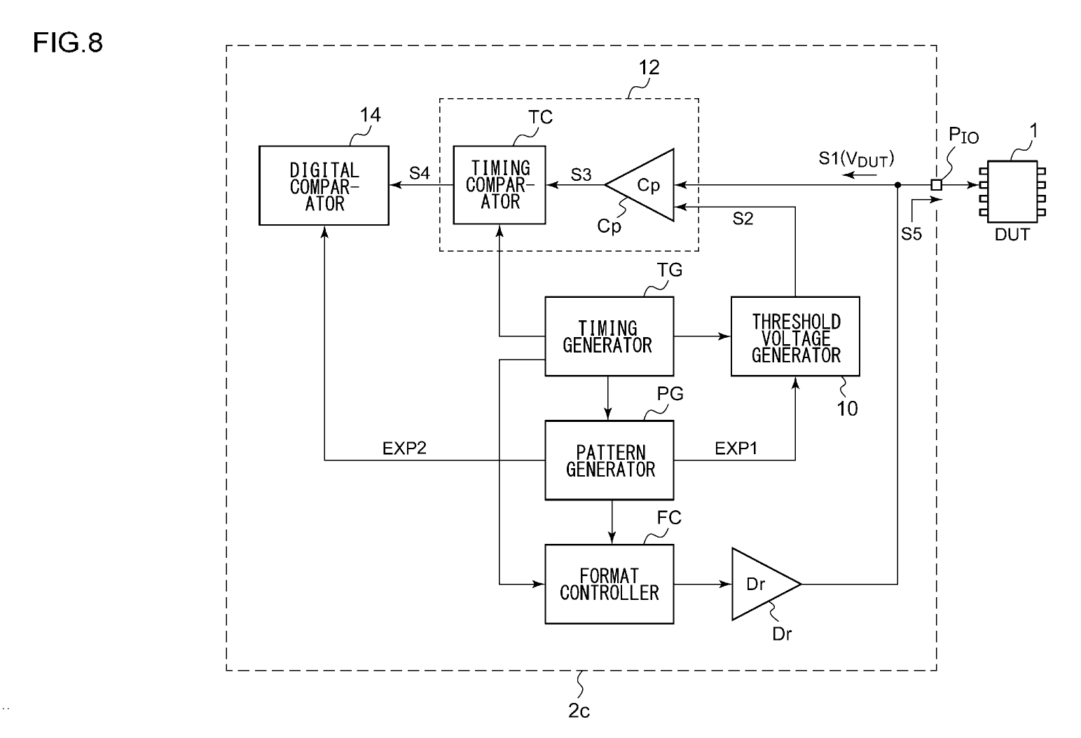

FIG. 8 is a block diagram which shows a configuration of a test apparatus 2c according to a fourth embodiment. The test apparatus 2c shown in FIG. 8 includes a driver Dr and a format controller (waveform shaper) FC, in addition to the configuration of the test apparatus 2 shown in FIG. 1. The test apparatus 2c is configured to transmit/receive signals to/from the DUT 1 via a single terminal (common I/O) that functions as both the input terminal and the output terminal. That is to say, such an arrangement is configured to perform bidirectional signal transmission via a single transmission line.

The pattern generator PG is configured to generate a test pattern which represents a pattern of a test signal to be supplied to the DUT 1. The test pattern corresponds to the aforementioned expected value pattern EXP.

The format controller FC is configured to receive the test pattern and the timing control signal, and to generate a test signal sequence to be supplied to the DUT 1. The driver Dr is configured to output the test signal sequence S5 to the DUT 1 via the I/O terminal P_{IO}. With the configuration shown in FIG. 8, such an arrangement is capable of testing a DUT 1 including a bidirectional interface.

Description has been made regarding the present invention with reference to the embodiments. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

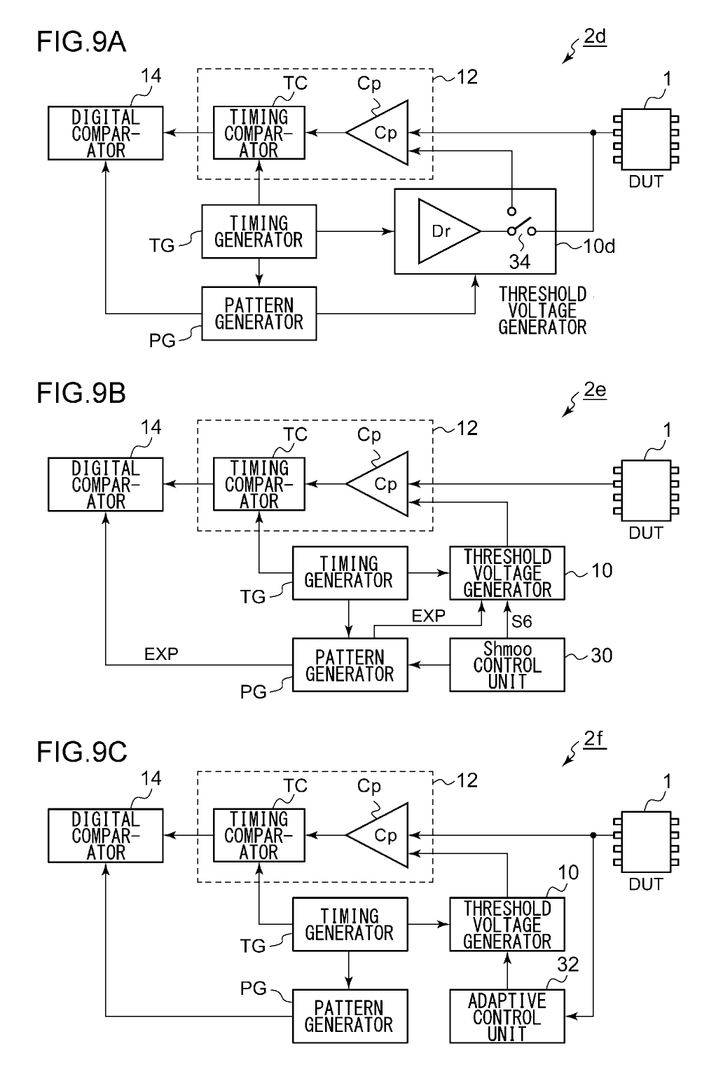

FIGS. 9A through 9C are block diagrams showing the configurations of test apparatuses according to a first modification through a third modification, respectively. Such modifications may be combined with any one of the aforementioned embodiments, which are also encompassed in the technical scope of the present invention.

A test apparatus 2d shown in FIG. 9A is configured as a modification of the test apparatus 2c shown in FIG. 8, and has a configuration in which the threshold voltage generator 10d also provides a function as the driver Dr. In bidirectional transmission, in some cases, signal transmission and reception are performed in a time sharing manner. With such an arrangement, a switch 34 may be further arranged to switch the connection state between a state in which the output of the driver Dr is connected to the DUT 1 and a state in which the output of the driver Dr is connected to the level comparator Cp. By employing such a CML driver Dr as the threshold voltage generator 10d, such an arrangement provides a reduced circuit area, thereby reducing hardware costs.

A test apparatus 2e shown in FIG. 9B further includes a shmoo control unit 30. The test apparatus 2e is capable of changing the timing (data rate) in an on-the-fly manner by means of RTTC (real timing control). By combining such a function of changing timing with the aforementioned function of changing the threshold voltage in a real-time manner, such an arrangement is capable of generating a shmoo plot.

Specifically, the threshold voltage generator 10 is configured to receive the expected value pattern EXP from the pattern generator PG and the control signal S6 from the shmoo control unit 30. With such an arrangement, the threshold voltage generator 10 is configured to sequentially change the voltage level of the threshold voltage sequence S2 in a real-time manner according to the control signal S6.

With conventional shmoo plot tests, there is a need to repeatedly perform a test operation in which the signal under test S1 is tested and the signal under test S1 is reset, for each comparison voltage to be supplied to the level comparator Cp, while the comparison voltage (threshold voltage) is swept. In contrast, with the test apparatus 2e shown in FIG. 9B, such an arrangement provides a shmoo plot test in a real-time manner, thereby dramatically reducing the period of time required to execute the shmoo plot test.

A test apparatus 2f shown in FIG. 9C includes an adaptive control unit 32. The adaptive control unit 32 is configured to monitor the voltage level V_{DUT} of the signal under test S1 input to the I/O terminal P_{IO}, and to feed the result back to the terminal voltage generator 20 and the D/A converter 26 included in the threshold voltage generator 10. That is to say, the adaptive control unit 32 adaptively controls the level of the threshold voltage according to the signal under test S1. Thus, such an arrangement is capable of adaptively executing a test for a device that allows amplitude fluctuation or offset fluctuation of the output signal.

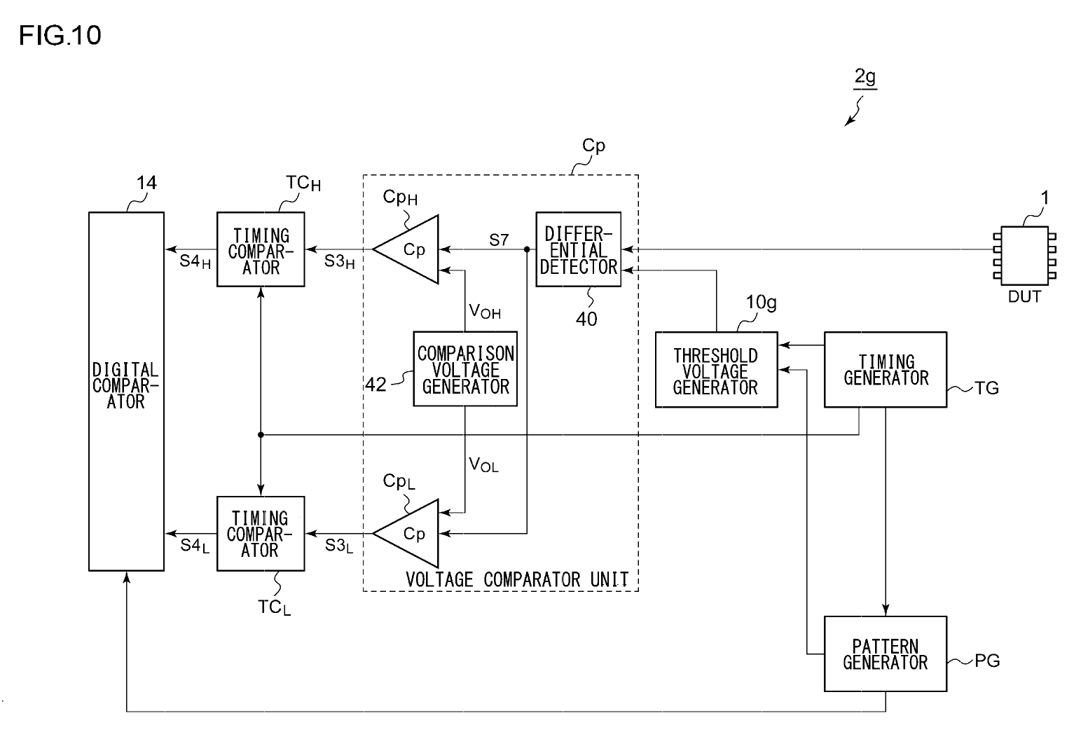

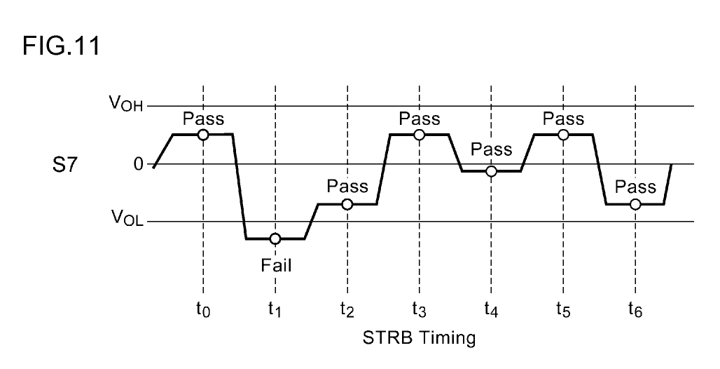

FIG. 10 is a block diagram which shows a modification of the test apparatus shown in FIG. 4. FIG. 11 is a time chart which shows the operation of a test apparatus 2g shown in FIG. 10. In the test apparatus 2g shown in FIG. 10, the level comparator Cp includes a first comparator Cp_{H}, a second comparator Cp_{L}, a differential detector 40, and a comparison voltage generator 42.

The threshold voltage generator 109 is configured to generate a threshold voltage sequence S2 that corresponds to the expected voltage level V_{EXP} to which the signal under test S1 is to be set at each strobe timing. At each strobe timing, the differential detector 40 is configured to generate a differential signal S7 which represents the difference between the voltage level V_{DUT} of the signal under test S1 and the expected voltage level V. The comparison voltage generator 42 is configured to generate a first threshold voltage V_{OH} which defines the upper limit that is allowable for the differential signal S7, and a second threshold voltage V_{OL} which defines its lower limit. The level comparators Cp_{H} and Cp_{L} are respectively configured to compare the voltage level of the differential signal S7 with the first threshold voltage V_{OH} and V_{OL}. The timing comparators TC_{H} and TC_{L} are respectively configured to latch the output signals S3_{H} and S3_{L} of the respective level comparators Cp_{H} and Cp_{L} at a strobe timing.

With the test apparatus 2g shown in FIG. 10, the differential signal S7 which represents the difference (V_{DUT}-V_{EXP}) is compared with the two threshold voltages V_{OH} and V_{OL}. When V_{OL}<V_{DUT}−V_{EXP}<V_{OH}, i.e., when V_{OL}+V_{EXP}<V_{DUT}<V_{OH}+V_{EXP}, a pass judgment is made. Otherwise, a fail judgment is made. That is to say, the two level comparators Cp_{H} and Cp_{L} function as a window comparator, thereby providing judgment of the quality of the DUT 1, as with the test apparatus 2a shown in FIG. 4.

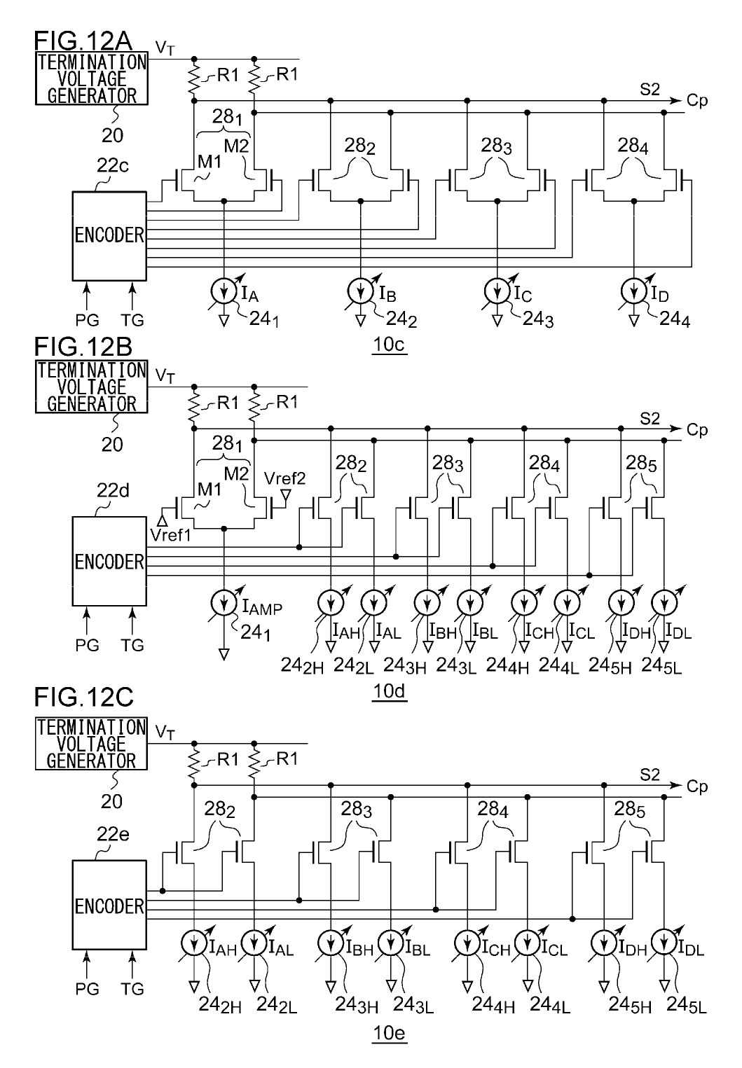

Lastly, description will be made regarding a modification of the threshold voltage generator 10. FIGS. 12A through 12C are circuit diagrams each showing a configuration of a threshold voltage generator according to a modification.

A threshold voltage generator 10c shown in FIG. 12A has a configuration modified from the configuration of the threshold voltage generator 10a shown in FIG. 2A such that it is operated in a differential manner. Each switch 28 shown in FIG. 2A is replaced by a differential transistor pair M1 and M2. Each current source 24 that corresponds to a switch 28 is connected as a tail current source for the differential transistor pair M1 and M2. Furthermore, two resistors R1 are arranged such that they respectively function as the loads of the transistor M1 and M2 for each differential transistor pair.

The encoder 22c is configured to control the differential transistor pair M1 and M2 arranged for each of the multiple switches 28₁ through 28₄.

The threshold voltage generator 10c shown in FIG. 12A has a differential configuration, thereby generating the threshold voltage sequence S2 that follows the signal under test S1 even if the signal under test S1 is supplied at high rate.

A threshold voltage generator 10d shown in FIG. 12B is configured as a modification of the threshold voltage generator 10c shown in FIG. 12A. The differential transistors M1 and M2 that form the switch 28₁ are biased by reference voltages Vref1 and Vref2, respectively. With such an arrangement, a current flows according to the bias state. That is to say, the reference level of the threshold voltage sequence S2 is determined by the reference voltages Vref1 and Vref2.

For each of the other switches 28₂ through 28₅, two transistors M1 and M2 that form a transistor pair are connected to separate tail current sources 24H and 24L, respectively. The encoder 22d is configured to control the on/off states of the transistors M1 and M2 of each of the switches 28₂ through 28₅.

A threshold voltage generator 10e shown in FIG. 12C has a configuration obtained by eliminating the switch 28₁ and the current source 24₁ from the configuration of the threshold voltage generator 10c shown in FIG. 12B.

With such a configuration shown in FIGS. 12B and 12C, such an arrangement provides improved tolerance of transistor and current source mismatch.

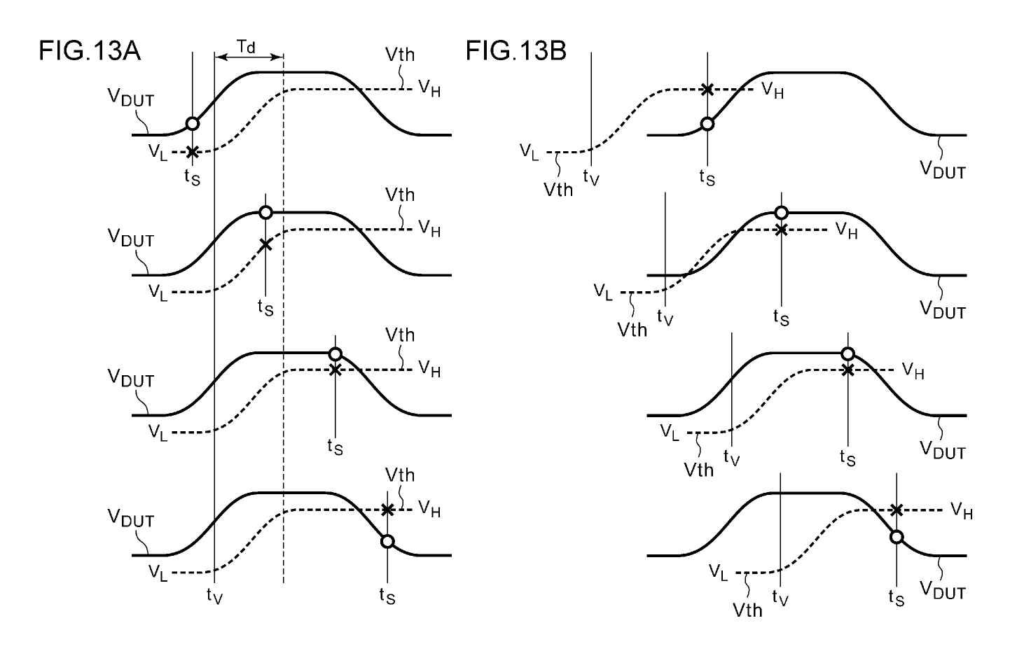

Next, description will be made regarding the timing setting for the threshold voltage generator 10 and the comparator unit 12. FIGS. 13A and 13B are diagrams each showing the relation between the threshold voltage Vth and the signal under test V_{DUT}(S1). In actuality, the threshold voltage generator 10 requires a certain amount of delay (settling time) to stabilize the threshold voltage Vth after the expected value data (control data) EXP1 is set (setting timing t_{V}). If the strobe timing t_{S} is generated before the threshold voltage Vth is stabilized to a voltage level that corresponds to the control data EXP1, judgment cannot be made correctly. Such a period of time required to stabilize the threshold voltage Vth will be referred to as the “dead band Td”.

FIG. 13A shows a case in which the setting timing t_{V} and the strobe timing t_{S} are set non-synchronously. With such an arrangement, in some cases, the strobe timing t_{S} is generated in the dead band Td depending on the time difference between the setting timing t_{V} and the strobe timing t_{S}.

This problem can be solved by synchronously setting the setting timing t_{V} and the strobe timing t_{S}. FIG. 13B shows an arrangement in which the setting timing t_{V} and the strobe timing t_{S} are generated synchronously, i.e., are generated with a constant time offset between the two timings. Such an arrangement ensures the settling of the threshold voltage Vth at the strobe timing t_{S} regardless of the voltage level V_{DUT} of the signal under test S1 at the strobe timing t_{S}.

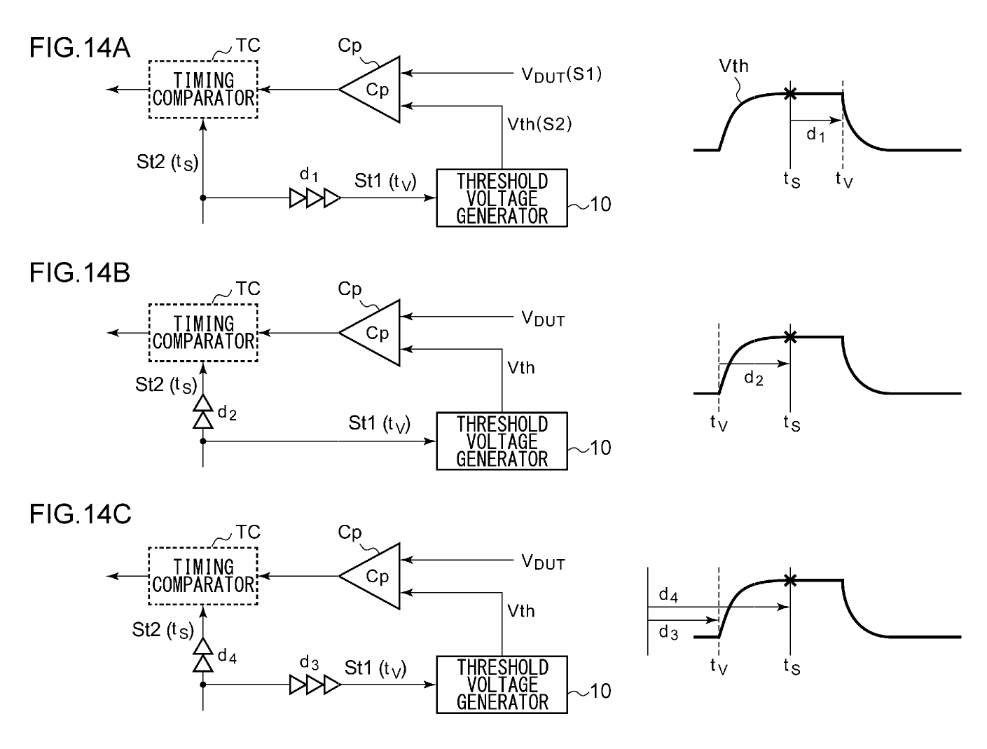

Next, description will be made regarding an arrangement configured to synchronously generate the setting timing t_{V} and the strobe timing t_{S}. FIGS. 14A through 14C each show a circuit configured to generate a timing signal and the corresponding waveform. FIG. 14A shows an arrangement in which the strobe timing t_{S} generated by a timing generator TG (not shown) is delayed by a delay circuit d₁ so as to generate the setting timing t_{V}.

FIG. 14B shows an arrangement in which the setting timing tv generated by a timing generator TG (not shown) is delayed by a delay circuit d₂ so as to generate the strobe timing t_{S}. FIG. 14C shows an arrangement in which a common base timing signal S8 generated by a timing generator TG (not shown) is delayed by a delay circuit d₃ so as to generate the strobe timing t_{S}, and the common base timing signal S8 is delayed by a delay circuit d₄ so as to generate the setting timing t_{V}. As the base timing signal, the strobe signal generated by the timing generator TG may be employed.

With such a configuration shown in FIG. 14A, the threshold voltage Vth at the next cycle is set using the strobe timing t_{S} at a given cycle. Thus, such an arrangement has a problem in that the first data of the signal under test S1 cannot be tested.

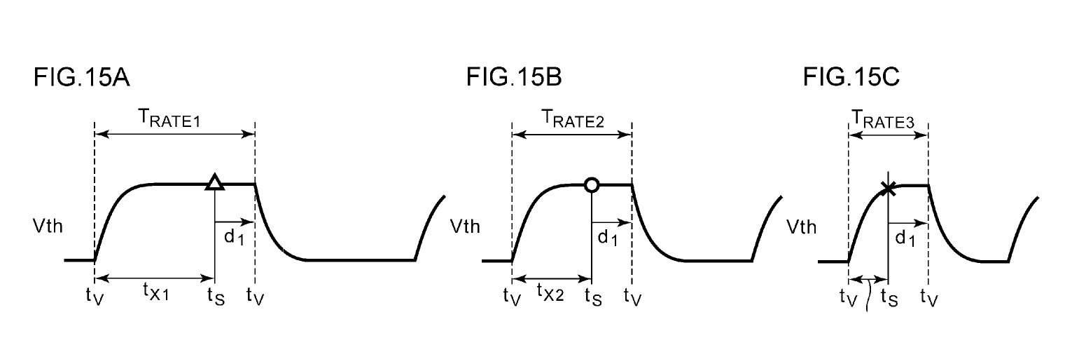

However, such a configuration shown in FIG. 14A has an advantage of providing evaluation of the waveform of the threshold voltage Vth generated by the threshold voltage generator 10. With the configuration shown in FIG. 14A, by changing the period (test rate) of the signal under test S1 while maintaining the delay time d₁ at a constant value, such an arrangement is capable of changing the interval t_{X} between the setting timing t_{V} and the strobe timing t_{S}. FIGS. 15A through 15C are diagrams showing the waveforms of the threshold voltage Vth provided by the configuration shown in FIG. 14A with the test rate having been changed.

Evaluation of the waveform of the threshold voltage Vth can be performed as follows. First, the test rate T_{RATE} is fixed at a predetermined value. In this state, a reference voltage Vref is input to the input terminal of the level comparator Cp instead of the signal under test S1, and the level of the reference voltage Vref is sequentially changed. With such an operation, the value of the comparison signal S4 is inverted with a particular reference voltage as the boundary. The reference voltage Vref at the boundary represents the voltage level of the threshold voltage Vth for a given time interval t_{X}.

Such an operation is repeatedly performed while changing the test rate T_{RATE}, i.e., while changing the time interval t_{X}, thereby acquiring the waveform of the threshold voltage Vth. Thus, such an arrangement provides evaluation of the characteristics of the threshold voltage generator 10, such as the settling time and so forth.

There is a need to perform phase matching with high precision for the setting timing t_{V} defined by the first timing signal St1 and the strobe timing t_{S} defined by the second timing signal St2 with respect to the signal under test S1. However, in a case in which the first timing signal St1 is generated by means of such a configuration shown in FIGS. 14A through 14C, for example, in some cases, this leads to deviation of the setting timing t_{V} or the strobe timing t_{S} from a desired timing due to process variation in the delay amount to be applied by the delay circuit, or otherwise due to fluctuation in the delay amount caused by fluctuation in the temperature or fluctuation in the power supply voltage. Deviation of the phase of the setting timing t_{V} leads to a situation in which, at the strobe timing t_{S}, settling of the threshold voltage V_{TH} is not completed. Description will be made below regarding a modification according to a technique for optimizing the setting timing t_{V}.

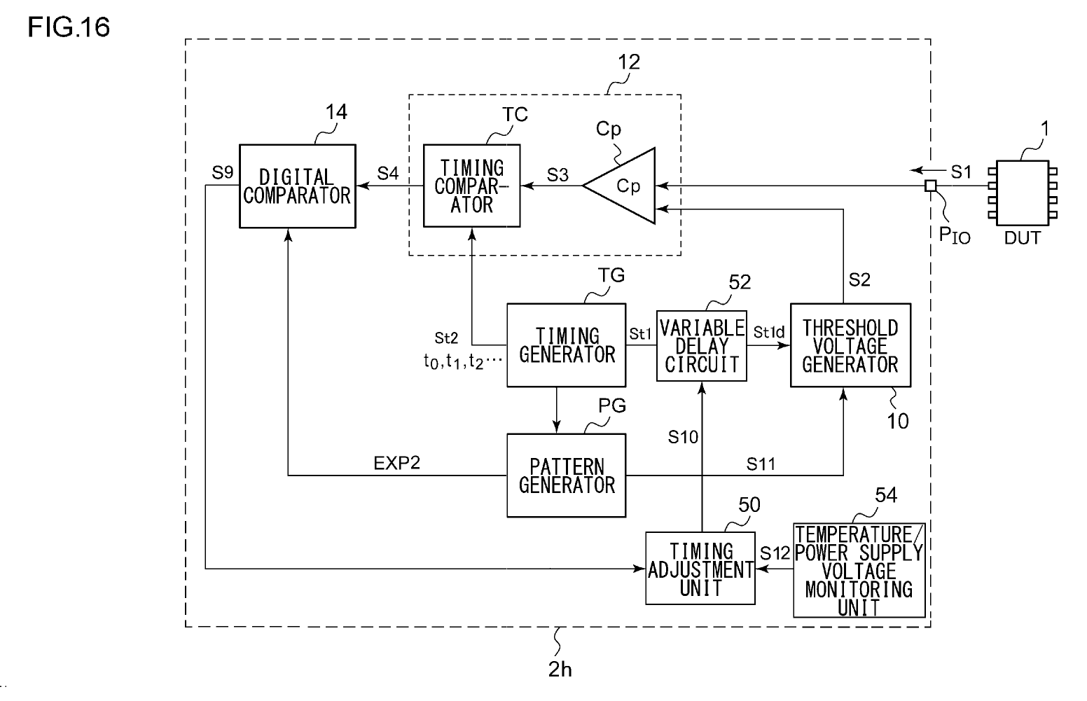

FIG. 16 is a block diagram which shows a configuration of a test apparatus 2h which is capable of optimizing the setting timing t_{V} for the threshold voltage Vth.

The test apparatus 2h further includes a timing adjustment unit 50 and a variable delay circuit 52, in addition to the configuration of the test apparatus 2 shown in FIG. 1.

The timing adjustment unit 50 is configured to adjust the phase of the first timing signal St1 relative to the second timing signal St2. The variable delay circuit 52 is configured to apply an adjustable delay τd to the timing signal St1 generated by the timing generator TG so as to generate a first timing signal St1d. The variable delay circuit 52 may be configured as a part of the timing generator TG. The timing generator TG having a typical configuration includes a variable delay circuit as a built-in component. Thus, such a variable delay circuit included in the timing generator TG may also be used as the variable delay circuit 52.

The calibration provided by the timing adjustment unit 50 can be applied to any one of the configurations shown in FIGS. 14A through 14C.

With the configuration shown in FIG. 14A, the delay circuit d₁ may be replaced by the variable delay circuit 52 so as to apply a delay amount τd to the second timing signal St2, thereby generating the first timing signal St1.

With the configuration shown in FIG. 14B, the second timing signal St2 is generated by applying a delay to the first timing signal St1. With such an arrangement, a delay circuit configured as an internal component of the timing generator TG may preferably be employed as the variable delay circuit 52.

Also, the delay circuit d2 may be configured to function as the variable delay circuit 52. By applying a delay amount τd to the second timing signal St2 relative to the first timing signal St1, the phase of the first timing signal St1 may be adjusted relative to the second timing signal St2.

With the configuration shown in FIG. 14C, the delay circuit d3 configured to delay the base timing signal generated by the timing generator TG may preferably be employed as the variable delay circuit 52.

In order to adjust the delay amount τd, a calibration operation is executed as described below. In the calibration operation, a predetermined calibration signal is input to the I/O terminal P_{IO}. The timing adjustment unit 50 adjusts the phase of the first timing signal St1d based upon the judgment signal S9 generated in this stage.

Specific description will be made regarding an example of the operation for calibration of the first timing signal, assuming that the calibration of the second timing signal St2 has been completed before the calibration of the first timing signal St1. The calibration of the second timing signal St2 relative to the signal under test S1 may preferably be made using known techniques.

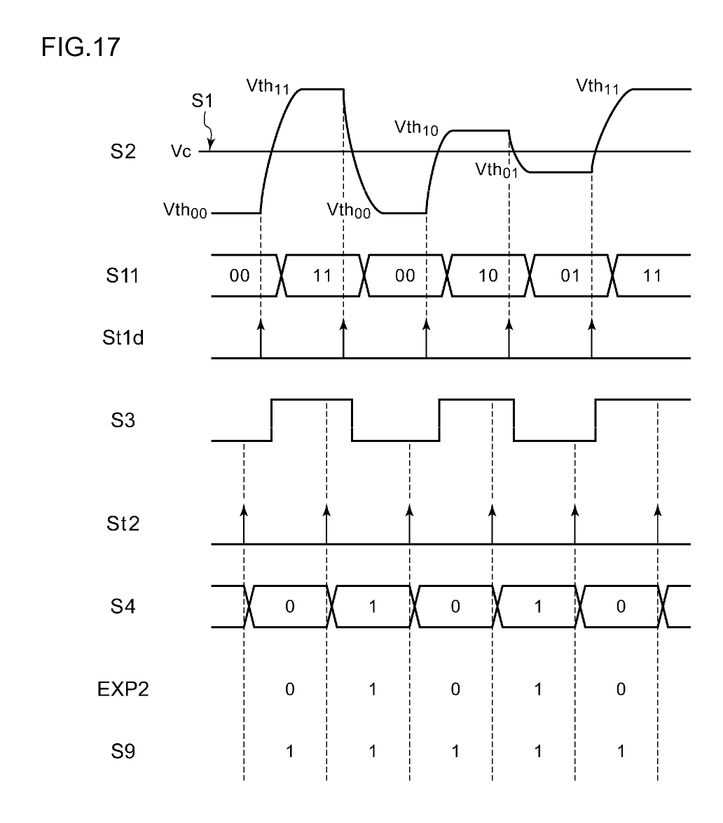

FIG. 17 is a waveform diagram which shows an example of the operation for calibration of the first timing signal (the threshold voltage setting timing t_{V}) performed by the test apparatus 2h.

In the operation for calibration of the first timing signal St1, a predetermined fixed voltage Vc is input as a calibration signal S1. The fixed voltage Vc may be configured as a midpoint voltage of the signal under test S1. The pattern generator PG is configured to generate control data S11 having a value that changes for each test cycle. It should be noted that the control data S11 is distinct from the control data EXP1 that corresponds to the expected value data EXP used in the normal test operation.

The data values “00”, “01”, “10”, and “11” of the control data S11 correspond to the threshold voltages Vth₀₀, Vth₀₁, Vth₁₀, and Vth₁₁, respectively. The pattern of the control signal S11 is not restricted in particular. However, the pattern of the control data S11 is preferably determined such that the threshold voltage Vth changes such that it crosses the fixed voltage Vc for every test cycle.

The control data S11 is set for the threshold voltage generator 10 at the setting timing t_{V} specified by the first timing signal St1d. Thus, the threshold voltage sequence S2 (Vth) has a voltage level that changes with the setting timing t_{V} as the start point, and is stabilized to a voltage level specified by the control data S11 after the settling time elapses. The settling time changes depending on the combination of the voltage levels before and after the transition. Thus, the control data S11 is preferably determined so as to obtain a long settling time for the threshold voltage Vth, or otherwise to obtain various settling time values.

A comparison signal S3 which represents the comparison result between the signal under test S1 and the threshold voltage sequence S2 is latched by the timing comparator TC at every strobe timing tₛ defined by the second timing signal St2, thereby generating the comparison data S4.

In the calibration operation, the pattern generator PG generates the expected value data EXP2 which represents an expected value for the comparison result between the threshold the threshold voltage Vth that corresponds to the control data S11 and the fixed voltage Vc. For every cycle, the digital comparator 14 compares the comparison signal S4 with the expected value data EXP2 so as to generate the judgment signal S9 which represents Pass (1) or Fail (0).

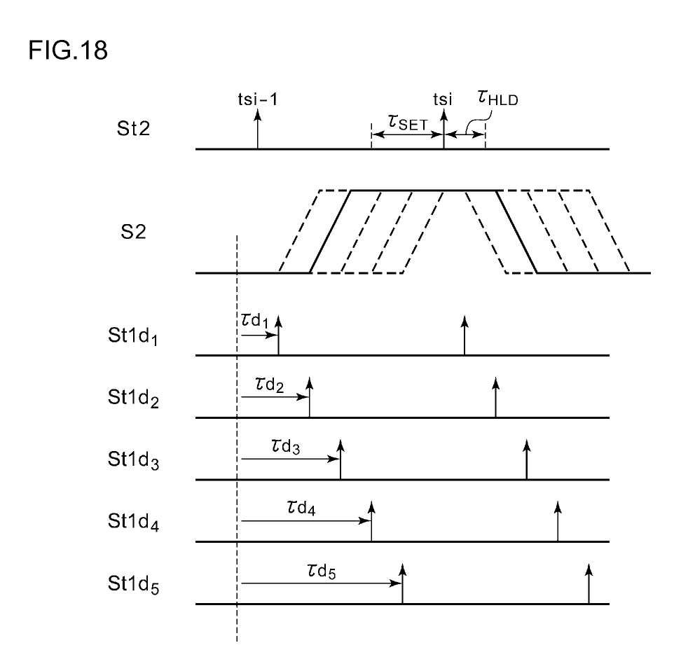

FIG. 18 is a waveform diagram which shows the relation between the threshold voltage Vth and the first timing signal St1. By changing the delay amount τd supplied from the variable delay circuit 52, such an arrangement is capable of changing the time point at which the threshold voltage Vth starts to change, and the time point at which the threshold voltage Vth becomes stable, according to the delay amount τd.

Description will be made below directing attention to the i-th cycle. In order to provide a test with high accuracy, such an arrangement requires the settling of the threshold voltage Vth to be completed a predetermined setup time τ_{SET} before the strobe timing t_{Si} defined by the second timing signal St2. Furthermore, such an arrangement requires the threshold voltage Vth to be maintained at a constant value during a hold time τ_{HLD} after the strobe timing t_{Si}. The setup time τ_{SET} and the hold time τ_{HLD} are values characteristic of a latch or otherwise of a flip-flop employed in the timing comparator TC.

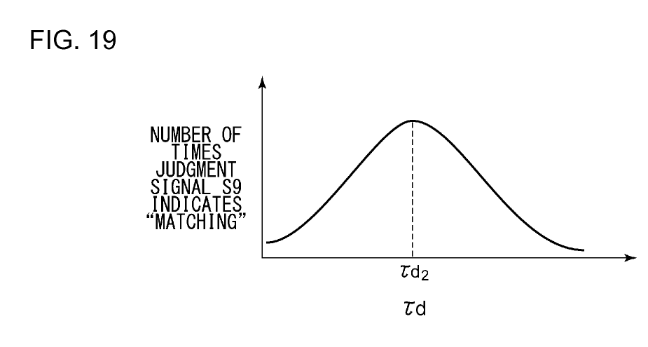

FIG. 19 is a graph showing the relation between the delay amount τd applied by the variable delay circuit 52 and the number of times (probability) an event occurs in which the judgment signal S9 indicates matching. In FIG. 18, when the delay amount is set to τd₂, such an arrangement provides a suitable phase relation between the first timing signal St1 and the second timing signal St2, thereby providing a suitable setup time τ_{SET} and a suitable hold time τ_{HLD}. In this state, if the judgment signal S9 is monitored over a certain period of time, the judgment signal S9 will indicate matching over all the cycles.

On the other hand, when the first timing signal St1 or the second timing signal St2 deviates from its suitable timing, the judgment signal S9 indicates mismatching for several cycles. That is to say, the number of times an event occurs in which the judgment signal S9 indicates matching changes according to the delay amount τd applied to the first timing signal St1.

Thus, by changing the delay amount in the order τd₁, τd₂, τd₃, and so forth, applied by the variable delay circuit 52, the timing adjustment unit 50 sweeps the phase of the first timing signal St1 relative to the second timing signal St2 and the signal under test S1. Furthermore, such an arrangement is configured to monitor the judgment signal S9 over a sufficiently large number of cycles, to count the number of times the judgment signal S9 indicates “matching (1)” (or otherwise the number of times the judgment signal S9 indicates mismatching), and to determine, based upon the number of times thus counted, the phase of the first timing signal St1d to be set in the normal test operation. Preferably, the delay amount τd that provides the highest probability of an event occurring in which the judgment signal indicates matching is selected as the delay amount τd to be used in the normal test operation. Also, as the delay amount to be used in the normal test operation, a delay amount obtained by adding a margin to or by subtracting a margin from the delay amount τd thus determined in the calibration may be employed.

More specifically, the timing adjustment unit 50 is configured to set, as the initial value of the delay amount τd, the maximum value τd₅ that can be set for the variable delay circuit 52, and to decrement the delay amount τd in the order τd₅, τd₄, τd₃, and so forth. When the delay amounts τd₅, τd₄, and τd₃ are excessively large, the setup requirement for the timing comparator TC is not satisfied. This increases the number of times the judgment signal S9 indicates mismatching. According to a reduction in the delay amount τd, such an arrangement provides an increase in the number of times the judgment signal S9 indicates matching. When the optimum delay amount τd₂ is applied, the judgment signal S9 indicates matching over all the cycles. The timing adjustment unit 50 stores the optimum delay amount τd₂ in the variable delay circuit 52, and the calibration operation ends.

In a case in which there is no need to give consideration to the hold time τ_{HLD}, the delay amount τd may be determined as follows. In this case, when the delay amount is set to τd1 or τd₂, the setup requirement for the timing comparator TC is satisfied, which provides the maximum number of times the judgment signal S9 indicates matching. When the delay amount is greater than τd₃, the number of times the judgment signal S9 indicates matching starts to decrease. Thus, the timing adjustment unit 50 is configured to set, as the initial value of the delay amount τd, the maximum value τd₁ that can be set for the variable delay circuit 52, and to increment the delay amount in the order τd₂, τd₃, τd₄, and so forth. When the delay amount is smaller than a particular value, the judgment signal S9 indicates matching over all the cycles. When the delay amount is greater than a particular value, the setup requirement for the timing comparator TC is not satisfied. In this state, in some cases, the judgment signal S9 indicates mismatching. When the timing adjustment unit 50 detects the judgment signal S9 indicating mismatching, the calibration operation ends. Subsequently, a delay amount that is smaller than the delay amount that leads to detection of mismatching is stored in the variable delay circuit 52.

As described above, with the test apparatus 2h shown in FIG. 16, such an arrangement is capable of automatically optimizing the timing of the first timing signal St1 under various kinds of environments such as various temperature environments, power supply voltage environments, etc.

The temperature and the power supply voltage of the test apparatus 2h can change over time in the test operation. Accordingly, the delay amount τd to be applied to the first timing signal St1 can change due to changes in the test environment, such as changes in the temperature, power supply voltage, etc. Thus, the test apparatus 2h may further include a monitoring unit 54 configured to monitor the temperature and/or the power supply voltage. When the temperature or the power supply voltage meets the requirement for setting the timing of the first timing signal St1 again, the monitoring unit 54 instructs the timing adjustment unit 50 to perform the calibration operation again.

It should be noted that the calibration operation requires a relatively long period of time. Thus, it is undesirable for such a calibration operation to be performed frequently in the test operation for the DUT 1. In order to solve such a problem, the aforementioned calibration operation may be executed beforehand under various temperature conditions and power supply voltage conditions, and the optimum delay amount τd may be determined by measurement for each combination of the temperature and the power supply voltage, i.e., for each test environment. Also, such an arrangement may include memory configured to hold a table which represents the relation between the test environment and the optimum delay amount τd. With such an arrangement, the timing adjustment unit 50 may determine the optimum delay amount τd with reference to the table held by the memory based upon the temperature and the power supply voltage measured by the monitoring unit 54, and may set the optimum delay amount τd for the variable delay circuit 52. Such an arrangement is capable of preventing the calibration operation from being performed frequently in the test operation.

It should be noted that the aforementioned calibration operation has been described for exemplary purposes only. Rather, it can be readily conceived by those skilled in this art that various modifications may be made with respect to the calibration performed by the timing adjustment unit 50, which are also encompassed in the technical scope of the present invention.

Description has been made in the embodiment regarding an arrangement in which the timing adjustment unit 50 adjusts the phase of the first timing signal St1 based upon the judgment signal S9. However, the present invention is not restricted to such an arrangement. For example, the phase of the first timing signal St1 may be adjusted based upon the comparison signal S4 instead of the judgment signal S9.

Description has been made in the embodiment regarding an arrangement in which the fixed voltage Vc is input as the signal under test S1 in the calibration for the first timing signal St1. However, the present invention is not restricted to such an arrangement. Also, in the calibration operation, the timing of the first timing signal St1 may be adjusted under more severe conditions with the signal under test S1 being dynamically changed.

Also, the adjustment of the first timing signal St1 performed by the timing adjustment unit 50 can be applied to various kinds of test apparatuses such as those shown in FIG. 4, FIG. 6, FIG. 8, FIGS. 9A through 9C, and FIG. 10, which are encompassed in the technical scope of the present invention.

While the preferred embodiments of the present invention have been described using specific terms, such description is for illustrative purposes only, and it is to be understood that changes and variations may be made without departing from the spirit or scope of the appended claims.

What is claimed is:

1. A test apparatus configured to test a signal under test which is output from a device under test, and which has a voltage level that changes according to its value, the test apparatus comprising:
an input pin configured to receive the signal under test as an input signal;
a pattern generator configured to generate control data that specifies a threshold voltage to be compared with the signal under test input to the input pin, and to generate expected value data which represents an expected value for the comparison result between the signal under test and the threshold voltage;
a threshold voltage generator configured to receive the control data, and to generate a threshold voltage having a voltage level that corresponds to the control data at every setting timing indicated by a first timing signal;
a level comparator configured to compare the voltage level of the signal under test with the corresponding threshold voltage;
a timing comparator configured to latch the output of the level comparator at a strobe timing indicated by a second timing signal so as to generate a comparison signal;
a digital comparator configured to compare the comparison signal with the expected value data, and to generate a judgment signal which indicates whether they are matching or mismatching; and
a timing adjustment unit configured to adjust the phase of the first timing signal relative to the signal under test and the second timing signal.

2. A test apparatus according to claim 1, wherein, in an operation for calibration of the first timing signal, a predetermined calibration signal is input to the input pin over a plurality of cycles,
and wherein the timing adjustment unit is configured to adjust the phase of the first timing signal relative to the signal under test and the second timing signal, based upon the judgment signal obtained for the plurality of cycles.

3. A test apparatus according to claim 2, wherein the timing adjustment unit is configured to perform an operation while the phase of the first timing signal is being swept,
and wherein the aforementioned operation comprises (1) acquiring the judgment signal for each cycle over the plurality of cycles, (2) counting the number of times an event occurs in which the judgment signal indicates matching or otherwise mismatching, and (3) determining, based upon the number of times thus counted, the phase of the first timing signal to be used in a normal test operation.

4. A test apparatus according to claim 1, wherein, in an operation for calibration of the first timing signal, a predetermined calibration signal is input to the input pin over a plurality of cycles,
and wherein the timing adjustment unit is configured to adjust the phase of the first timing signal relative to the signal under test and the second timing signal, based upon the comparison signal obtained for the plurality of cycles.

5. A test apparatus according to claim 4, wherein the timing adjustment unit acquires the comparison signal for each phase over a plurality of cycles of the first timing signal while the phase is being swept,
and wherein the timing adjustment unit determines, based upon the comparison signal thus acquired, the phase of the first timing signal to be employed in a normal test operation.

6. A test apparatus according to claim 2, wherein the calibration signal is configured as a predetermined fixed voltage,
and wherein the pattern generator is configured to generate the control data determined such that the threshold voltage is changed such that it crosses the fixed voltage in the calibration operation.

7. A test apparatus according to claim 4, wherein the calibration signal is configured as a predetermined fixed voltage,
and wherein the pattern generator is configured to generate the control data determined such that the threshold voltage is changed such that it crosses the fixed voltage in the calibration operation.

8. A test apparatus according to claim 1, further comprising a delay circuit configured to apply an adjustable delay to the second timing signal so as to generate the first timing signal,
wherein the timing adjustment unit is configured to adjust the delay amount to be applied by the delay circuit.

9. A test apparatus according to claim 2, further comprising a delay circuit configured to apply an adjustable delay to the second timing signal so as to generate the first timing signal,
wherein the timing adjustment unit is configured to adjust the delay amount to be applied by the delay circuit.

10. A test apparatus according to claim 4, further comprising a delay circuit configured to apply an adjustable delay to the second timing signal so as to generate the first timing signal,
wherein the timing adjustment unit is configured to adjust the delay amount to be applied by the delay circuit.

11. A test apparatus according to claim 1, further comprising a delay circuit configured to apply an adjustable delay to the first timing signal so as to generate the second timing signal,
wherein the timing adjustment unit is configured to adjust the delay amount to be applied by the delay circuit.

12. A test apparatus according to claim 2, further comprising a delay circuit configured to apply an adjustable delay to the first timing signal so as to generate the second timing signal,
wherein the timing adjustment unit is configured to adjust the delay amount to be applied by the delay circuit.

13. A test apparatus according to claim 4, further comprising a delay circuit configured to apply an adjustable delay to the first timing signal so as to generate the second timing signal,
wherein the timing adjustment unit is configured to adjust the delay amount to be applied by the delay circuit.

14. A test apparatus according to claim 1, comprising:
a timing generator configured to generate a base timing signal;
a first delay circuit configured to apply an adjustable delay to the base timing signal so as to generate the first timing signal; and
a second delay circuit configured to apply a delay to the base timing signal so as to generate the second timing signal,
wherein the timing adjustment unit is configured to adjust the delay amount to be applied by the first delay circuit.

15. A test apparatus according to claim 2, comprising:
a timing generator configured to generate a base timing signal;
a first delay circuit configured to apply an adjustable delay to the base timing signal so as to generate the first timing signal; and
a second delay circuit configured to apply a delay to the base timing signal so as to generate the second timing signal,
wherein the timing adjustment unit is configured to adjust the delay amount to be applied by the first delay circuit.

16. A test apparatus according to claim 4, comprising:
a timing generator configured to generate a base timing signal;
a first delay circuit configured to apply an adjustable delay to the base timing signal so as to generate the first timing signal; and
a second delay circuit configured to apply a delay to the base timing signal so as to generate the second timing signal,
wherein the timing adjustment unit is configured to adjust the delay amount to be applied by the first delay circuit.

17. A test apparatus according to claim 14, wherein the timing generator employs, as the base timing signal, a strobe signal that is asserted at a cycle in which the test apparatus is to perform a comparison operation.

18. A test apparatus according to claim 1, wherein a plurality of sets, each of which comprises the threshold voltage generator, the level comparator, and the timing comparator, are arranged for each input pin.

19. A test apparatus according to claim 18, wherein the plurality of threshold voltage generators assigned to the same input pin are configured to generate different respective threshold voltages,
and wherein the plurality of level comparators assigned to the same input pin are configured to receive the respective threshold voltages from the corresponding threshold voltage generators, and to operate as a window comparator.

20. A test apparatus according to claim 18, wherein the plurality of sets, each of which comprises the level comparator and the timing comparator, assigned to the same input pin are configured to operate as an interleaving comparator that operates in a time sharing manner.
